(19) United States
(12) Patent Application Publication
(10) Pub. No.: US 2006/0197399 A1
(43) Pub. Date: Sep. 7, 2006

(54) Motor

(75) Inventors: Nakaba Kataoka, Kyoto (JP); Keita Nakanishi, Kyoto (JP)

Correspondence Address: JUDGE & MURAKAMI IP ASSOCIATES, DOJIMIA BUILDING, 7TH FLOOR, 6-8 NISHITEMMA 2-CHOME, KITA-KU, OSAKA-SHI, 530-0047, JP

(73) Assignee: Nidec Corporation, Kyoto (JP)

(21) Appl. No.: 11/164,928

(22) Filed: Dec. 12, 2005

(30) Foreign Application Priority Data
Dec. 10, 2004 (JP) JP-2004-358114
Dec. 6, 2005 (JP) JP-2005-352009

(51) Int. Cl. H02K 1/00; H02K 1/28; H02K 1/12

(52) U.S. Cl. 310/216; 310/218; 310/259

(57) ABSTRACT

Motor having small torque ripple. In a core of an armature of a motor, teeth are disposed radially around a center axis, arrangement of pitch angles of the teeth having different picth angles, or arrangement of tip end widths of the teeth having different tip end widths is repeated three or more times in the circumferential direction, the number of teeth is greater than the number of poles of the field magnet and with this structure, the tip ends of the teeth are varied, and with this effect also, the torque ripple is reduced.

### BACKGROUND OF THE INVENTION

1. Field of Invention

The present invention relates to an electric motor.

2. Description of the Related Art

In recent years, a power steering system for directly assisting a steering operation of an automobile using an electric motor is in the actual use. Even when the revolution number of the engine is low, the steering operation can sufficiently be assisted by the electric power steering system. When it is unnecessary to assist the steering operation so much during the high speed driving of the automobile or the like, it is possible to suppress energy waste like a conventional hydraulic pump system using an engine as a driving source.

In the motor used for such an electric power steering system, since rotation characteristics of the motor has a direct effect on the steering feeling, it is desired to suppress, as low as possible, “pulsation of torque at the time of rotation” called “torque ripple” and “variation in external torque required for rotating the motor when the motor is not rotating” called “cogging torque.”

As methods for suppressing the torque ripple or cogging torque, there are known methods such as one in which an armature is provided with two teeth having different tip end widths alternately, one in which tip end widths and pitch angles of four teeth are alternately changed, and one in which conductive wires are wound around commutating poles between teeth. However, in any of these methods, sufficient performance that can be applied to the power steering system motor can not be obtained.

Generally, a rectangular wave energization driving method has a merit that great output can be obtained with inexpensive and simple control, but has a defect that the torque ripple is easily generated.

Hence, in a motor which is required to satisfy both low cost and natural operating feeling like a power steering system of an automobile, it is effective and important technical problem to reduce the torque ripple by a rectangular wave energization driving method.

### BRIEF SUMMARY OF THE INVENTION

The present invention has been accomplished in view of the above problem, and it is a main object of the invention to reduce the torque ripple (and cogging torque) of a motor.

To achieve the above object, the present invention provides an electric motor comprising a stator having an armature, a rotor having a field magnet for generating a torque around a center axis between the armature and the rotor, and a bearing mechanism for supporting the rotor around the center axis such that the rotor can rotate relative to the stator, wherein a plurality of teeth of a core of the armature are disposed radially around the center axis, a gap is formed between inner tops of adjacent teeth and a pitch angle of the gap is defined around the center axis, a pitch angle arrangement set which has at least two different pitch angles formed between the adjacent teeth is defined, the pitch angle arrangement set is repeated three or more times in the circumferential direction around the center axis, the number of teeth is greater than the number of magnetic poles of the field magnet. With this structure, the torque ripple of the motor can be dispersed in the circumferential direction and reduced.

As a preferred mode, there is an armature having a plurality of teeth disposed radially around the center axis, wherein a tip end width is formed at inner top of tooth, an angle of a tip end width of tooth is defined around the center axis, a tip end width arrangement set which has at least two different tip end widths of the teeth is defined, the tip end width arrangement set may be repeated in accordance with the repetition of the pitch angle arrangement set arranged regularly in the circumferential direction around the center axis.

More specifically, it is preferable that the number of the teeth is twelve, the number of repetitions in the circumferential direction is three such that a total angle of the pitch angle arrangement set is 120°, and the number of poles of the field magnet in the circumferential direction around the center axis is four.

In other preferred modes, the driving method may be a rectangular wave energization method, the core may be formed by laminating thin steel sheets while rotating the same in accordance with the repetition of the pitch angle arrangement set, the tip end of the teeth may be directed to the center axis, and the field magnet may be opposed to inner peripheral surfaces of the teeth. The motor of the present invention may be a driving source which assists a driving operation of a vehicle, the motor may directly assist a power steering system of an automobile for example, and smooth operation assist can be realized.

### BRIEF DESCRIPTION OF THE SEVERAL VIEWS OF THE DRAWINGS

FIG. 1 is a vertical sectional view of a motor;

FIG. 2 is a plan view showing a core, a coil and a field magnet;

FIG. 3 is a diagram used for explaining driving current; and

FIG. 4 is a plan view showing the core.

### DETAILED DESCRIPTION OF THE INVENTION

### Best Mode for Carrying Out the Invention

An embodiment of the present invention will be explained using the drawings.

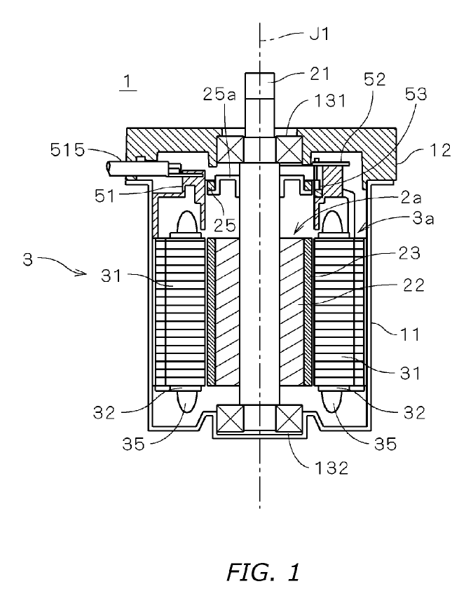

FIG. 1 is a vertical sectional view of an electric motor 1 according to an embodiment of the invention. The motor 1 is a so-called three-phase brushless motor. The motor 1 is used as a driving source which directly assists a power steering system of an automobile. In FIG. 1, hatching in detailed portion of the cross section is omitted. In FIG. 1, the motor 1 is covered with a cylindrical housing 11 whose upper side is opened, and with a cover 12. The cover 12 loses the opening of the housing 11 and is provided at its center with an opening. Ball bearings 131 and 132 are respectively provided in the opening of the cover 12 and the bottom surface of the housing 11. A shaft 21 of the motor is rotatably supported by the ball bearings 131 and 132.

A cylindrical rotor yoke 22 made of magnetic material is mounted on the shaft 21 in the housing 11. A field magnet 23 polarized with multipolar is fixed to an outer peripheral surface of the rotor yoke 22. For example, a sintered body including neodymium is used as the field magnet 23. An armature 3 is mounted on an inner peripheral surface of the housing 11 such as to be opposed to the field magnet 23. The armature 3 is disposed such that a center axis J1 of the armature 3 is aligned with a center axis of the shaft 21. The armature 3 includes a plurality of teeth 31 disposed radially around a center axis J1 such that tip ends of the teeth 31 are directed to the center axis J1 (i.e., extending from the inner peripheral surface of the housing 11 toward the shaft 21 and the field magnet 23), an insulator 32 for covering the teeth 31, and coils 35 provided by winding conductive wires around the teeth 31 from the insulator 32 in multi-layer manner. In the coil 35, the conductive wires are wound around the outer peripheries of the teeth 31 and the insulator 32 in the vertical direction (direction of the center axis J1).

A wire member made of a plurality of metal plates for supplying driving current to a coil 35 of the armature 3 is molded of resin to form a bus bar 51. The bus bar 51 is mounted on a cover 12 of the armature 3. A wire 515 and conductive wires of the coils 35 extending outside are connected to terminals of the wire members exposed from an outer periphery of the bus bar 51. A detecting circuit substrate 52 on which a Hall element 53 and the like are mounted is mounted on the cover 12 of the bus bar 51.

In the motor 1, a rotor 2a mainly comprising the rotor yoke 22 and the field magnet 23 is formed, and a stator 3a which mainly comprises the armature 3, the bus bar 51 and the circuit substrate 52 and which is fixed in the housing 11 is formed. The ball bearings 131 and 132 functions as bearing mechanisms for supporting the rotor 2a such that the rotor 2a can rotate around the center axis J1 relative to the stator 3a. If the driving current is supplied to the armature 3 through the bus bar 51, torque acting around the center axis J1 is generated between the armature 3 and the field magnet 23, and the rotor 2a rotates. The motor 1 is an inner rotor type motor in which the rotor 2a is disposed on the side of the center axis J1 of the stator 3a.

Three Hall elements 53 are mounted on the circuit substrate 52 such as to project downward together with various electronic components, and the Hall elements 53 are supported by sensor holders. In the shaft 21, an annular magnet 25 is mounted as a sensor on the cover 12 of the field magnet 23 through a flange 25a made of magnetic material. The sensor magnet 25 is opposed to the Hall element 53. Like the field magnet 23, the magnet 25 is polarized with multipolar. If the Hall element 53 detects a position of the magnet 25 (precisely, a position of a magnetic pole), the position of the field magnet 23 is indirectly detected. Driving current to the armature 3 is controlled based on the result of the detection. Since the flange 25a covers a side of the sensor magnet 25 facing the field magnet 23 and the armature 3, interference of magnetic fields of both of them can be prevented.

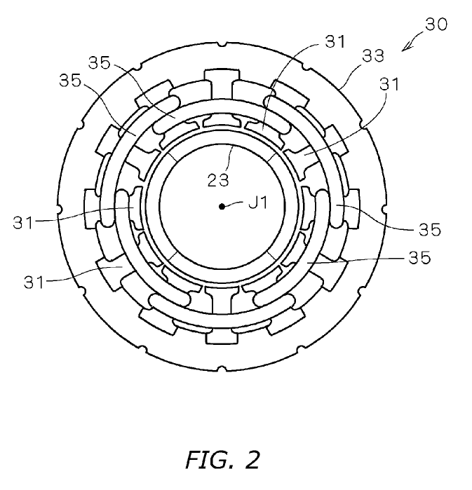

FIG. 2 is a plan view showing a core 30 and the coil 35 of the armature 3, and the field magnet 23. An insulator mounted on a surface of the core 30 (especially surfaces of the teeth 31) is omitted in FIG. 2.

The core 30 of the inner rotor type motor 1 includes twelve teeth 31 extending radially around the center axis J1 on an inner peripheral surface of a cylindrical support ring 33. Tip ends of the teeth 31 are directed toward the center axis J1 so that the field magnet 23 is opposed to the inner peripheral surface formed by the tip ends of the teeth 31. The core 30 is provided with total six coils 35, i.e., three coils 35 on the inner peripheral side and three coils 35 on the outer peripheral side. Each coil 35 extends through three teeth 31 (in a so-called distributed winding manner). A tip end of each tooth 31 on the side of the center axis J1 is a wide width in the circumferential direction, and a gap extending vertically between the tip ends is extremely small. Therefore, when the armature 3 is to be manufactured, an intermediate structure in which only the teeth 31 are connected to one another through temporarily connecting members on the side of the center axis J1 is first prepared, the insulator is mounted on the intermediate structure, conductive wire is wound from outside of the teeth 31 to form the coil 35 and then, the support ring 33 is mounted on the intermediate structure and the temporarily connecting member is removed. With this, the armature having the small gap between the tip ends of the teeth 31 can easily be manufactured.

The outer peripheral surface of the field magnet 23 is polarized with four poles, and each pole is distributed in a region of 90° around the center axis J1. The motor 1 is of a type having twelve slots and four poles due to a relation between the number of slots between the teeth 31 of the armature 3 and the number of magnetic poles of the field magnet 23.

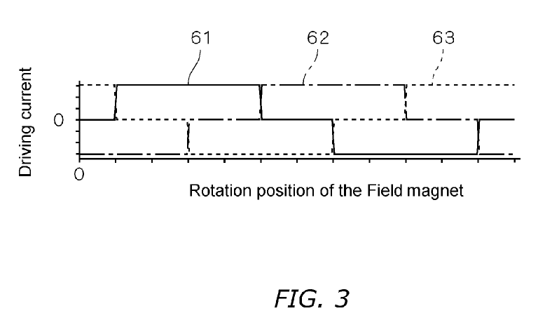

FIG. 3 is a graph showing variation of the driving current supplied to the coils 35. Lines shown with symbols 61 to 63 in FIG. 3 show three kinds of general rectangular waves when the motor 1 is driven by rectangular wave energization method. Rectangular wave 61 is supplied to a coil 35 of X-phase, rectangular wave 62 is supplied to a coil 35 of Y-phase and rectangular wave 63 is supplied to a coil 35 of Z-phase in this order in accordance with a rotation position of the field magnet 23 and with this, rotation magnetic field is produced around the field magnet 23, and torque is applied to the rotor 2a.

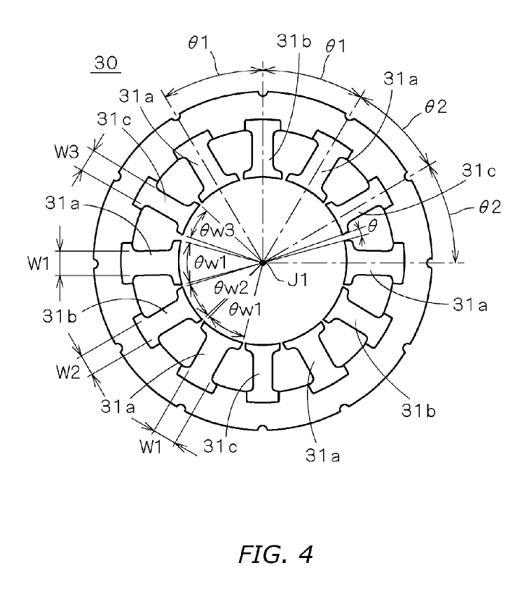

FIG. 4 is a plan view showing only the core 30 of the armature 3. There are three kinds of widths of tip ends of the teeth 31 of the core 30. Teeth are designated symbols 31a, 31b and 31c in the width-decreasing order, and FIG. 4 shows the tip end widths with angles θw1, θw2, and θw3 (θw1>θw2>θw3) formed around the center axis J1. The narrowest widths W1, W2 and W3 of the teeth 31a, 31b and 31c are reduced in this width-decreasing order (W1>W2>W3). As shown in FIG. 4, the teeth 31a , 31b, 31a, 31c are disposed around the center axis J1 in a clockwise direction in this order, and three sets of combinations of teeth are provided around the center axis J1. To reduce the force applied at the time of winding, there is employed a distribution winding which extends through three teeth 31 comprising teeth 31a having widest widths W1 and a tooth 31b or 31c interposed between the teeth 31a. With this, the widths of the tip ends of the adjacent teeth are different from each other.

As a result, the angle occupied by the tip ends of the continuous three teeth 31 around the center axis J1 is slightly different from 90°, the timings of torque ripple generated between each of the magnetic poles and the teeth 31 are extremely slightly deviated from each other, the torque ripple generated in all of the magnetic poles is dispersed, and torque ripple generated when the motor 1 rotates is reduced. Similarly, the cogging torque which is a variation of torque required for rotating the rotor 2a when it is not rotating is also dispersed and reduced. It is important to reduce the cogging torque when it is necessary to rotate the motor 1 by external force when the motor 1 is not energized, but it is conceived that if the cogging torque is reduced, the torque ripple is also reduced generally. In the following explanation, the torque ripple and the cogging torque are expressed as “torque ripple and the like.”

In the motor 1, the intervals of the teeth 31 are not constant, a pitch angle θ1 between the teeth 31a and the teeth 31b around the center axis J1 is 30°+α, and a pitch angle θ2 between the teeth 31a and the teeth 31c around the center axis J1 is 30°−α. There is a small deviation angle 2α between the pitch angle θ1 and θ2. And the angle α is 1° in this configuration. Therefore, the four pitch angles arranged between teeth 31a, 31b, 31a, 31c and 31a are 31°, 31°, 29°, 29° and the total angle is 120°. As described above, the field magnet 23 has four poles at pitch angle of 90° in the circumferential direction around the center axis J1, and the angle occupied by the three continuous teeth 31 is 89° or 91°. Thus, no matter which position the magnetic pole of the field magnet 23 is located, the centers of all of the magnetic poles of the field magnet 23 do not match with the center of the teeth 31 at the same time in any of transverse cross section. If the slot between the teeth 31 is reduced appropriately and the tip end width angles θw1, θw2, θw3 of the teeth 31 are appropriately selected, the center of all of the magnetic poles of the field magnet 23 does not match with the slot of the teeth 31 no matter where the magnetic pole of the field magnet 23 is located. In this structure, the slot angle θ between the tip ends of the teeth 31 around the center axis J1 is constant at any two teeth, and the selection may be made such that
θw1>30°, 30°−2(α+θ)>θw3, θw3>>α>0°, and 2α>θ≧θ0° while θw1+θw2+2θ=2θ1=2(30°+α), and θw1+θw3+2θ=2θ2=2(30°−α).
   And having an added condition of magnetic flux density balance 2θw3 >θw1, the selection may be made such that
2θw3>θw1, θw3>>α>0°, 2α,>θ≧0°, 40°−(4/3)(α30 θ)>θw1>30°, 30°−2(α+θ)>θw3>20°−(2/3)(α+θ), θw2=θw3+4α, and α=1°.
   That is, according to this configuration, any two or more magnetic pole boundaries of the field magnet 23 do not match with the slot between the teeth 31 at the same time in any of the transverse cross section, the magnetic circuit is not disordered, centers of any of two or more magnetic poles of the field magnet 23 do not match with the center of the tooth 31, and magnetic circuits having high a magnetic flux density are not formed at the same time. When the magnetic pole is provided with a skew, a three dimensional magnetic circuit can be formed, but it is possible to obtain a reducing effect of torque ripple together with smoothening effect of the skew.

With this, it is possible to further reduce the torque ripple and the like. Further, since the number of the teeth 31 is higher than the number of magnetic poles of the field magnet 23, the angle occupied by the tip end of one tooth 31 is smaller than the angle occupied by the magnetic poles of the field magnet 23, and the torque ripple and the like are further dispersed and reduced. Especially because the number of repetitions (three times) of the pitch angle arrangement set of the teeth 31 is not a multiple of the number of magnetic poles (four) of the field magnet 23, the torque ripple and the like can efficiently be dispersed and reduced.

Generally, according to the rectangular wave energization method, the torque ripple becomes greater than that of the sine wave energization method but the control circuit can be designed easily, and a cost of the motor 1 including a control system can be reduced. In the motor 1, by setting the pitch angles of the teeth 31 unevenly, the torque ripple can be reduced even with the rectangular wave energization method. Further, the motor 1 has twelve slots and four poles and thus, the number of slots and the number of poles can be reduced, the mechanism and control of the motor can be simplified, and both the reduction of the cost and reduction of the torque ripple and the like can be realized. Especially in the power steering system of an automobile, it is important to smoothly assist the operation and to reduce the cost.

The core 30 is formed by laminating thin silicon steel sheets. The shape of the core 30 is obtained by repeating the same shape through every 120° around the center axis J1 in accordance with the repetition of the pitch angle arrangement set. Therefore, it is possible to easily manufacture the core 30 in which magnetic characteristics are equal in the circumferential direction by superposing the thin steel sheets punched out using the same mold while rotating the steel sheets through 120° (so-called rotation lamination is carried out).

### Other Embodiments

Although the embodiment of the present invention has been explained above, the invention should not be limited to the embodiment and the invention can variously be modified.

In the embodiment, the arrangement of the four pitch angles between the teeth 31a, 31b, 31a, 31c and 31a is repeated three times in the circumferential direction around the center axis J1. Alternatively, the arrangement may be repeated three or more times. The arrangement of the pitch angles to be repeated is not limited to that of the embodiment, and other arrangement may also be employed only if any one of pitch angles is different from other pitch angles. At that time, since the range occupied by one tooth 31 is varied in accordance with the magnitude of the pitch angle, it is preferable that the tip end width of the tooth 31 and the slot angles between the tip ends are changed in accordance with the pitch angle. That is, it is preferable that an arrangement of teeth in which a tip end width of any one of teeth 31 is different from a tip end width of any other tooth 31 is repeated in the circumferential direction around the center axis J1 in accordance with the repetition of the arrangement of the pitch angles. It is also preferable that the sizes are set such that any two or more magnetic pole boundaries of the field magnet 23 do not match with the slot between the teeth 31 in any of the transverse cross section, the magnetic circuit is not disordered, centers of any of two or more magnetic poles of the field magnet 23 do not match with the center of the tooth 31, and magnetic circuits having high a magnetic flux density are not formed. Although the motor 1 is the inner rotor type motor in the embodiment, the motor 1 may be an outer rotor type motor. It is preferable that utilizing the characteristics that the torque ripple and the like are small, the motor is used as various driving sources for realizing smooth assist of operation of a vehicle in addition to the automobile. The present invention may be applied to other motors of industrial use, domestic use OA use and the like.

That is, all of modifications existing within sprit and range of the present invention are included in the scope of claims of the present invention.

What is claimed is:

1. An electric motor comprising:
a stator having an armature;
a rotor having a field magnet for generating a torque around a center axis between the armature and the rotor; and
a bearing mechanism for supporting the rotor around the center axis such that the rotor can rotate relative to the stator; wherein
a plurality of teeth of a core of the armature are disposed radially around the center axis, a gap is formed between inner tops of adjacent teeth and a pitch angle of the gap is defined around the center axis, a pitch angle arrangement set which has at least two different pitch angles formed between the adjacent teeth is defined, the pitch angle arrangement set is repeated three or more times in the circumferential direction around the center axis, and
a number of teeth is greater than a number of magnetic poles of the field magnet.

2. The motor according to claim 1, wherein the motor is driven by a rectangular wave energization method.

3. The motor according to claim 2, wherein the motor is a driving source for assisting a driving operation of a vehicle.

4. The motor according to claim 1, wherein the core is formed by laminating thin steel sheets while rotating a direction of the sheets in accordance with a repetition of the pitch angle arrangement set.

5. The motor according to claim 4, wherein the motor is a driving source for assisting a driving operation of a vehicle.

6. The motor according to claim 1, wherein a number of repetitions of the pitch angle arrangement set is not a multiple of a number of the magnetic poles of the field magnet.

7. An electric motor comprising:
a stator having an armature;
a rotor having a field magnet for generating a torque around a center axis between the armature and the rotor; and
a bearing mechanism for supporting the rotor around the center axis such that the rotor can rotate relative to the stator; wherein
a plurality of teeth of a core of the armature are disposed radially around the center axis, a gap is formed between inner tops of adjacent teeth and a pitch angle of the gap is defined around the center axis, a pitch angle arrangement set which has at least two different pitch angles formed between the adjacent teeth is defined, the pitch angle arrangement set is repeated three or more times in the circumferential direction around the center axis,
a number of teeth is greater than a number of magnetic poles of the field magnet, and
a tip end width is formed at inner top of tooth, an angle of a tip end width of tooth is defined around the center axis, a tip end width arrangement set which has at least two different tip end widths of the teeth is defined, the tip end width arrangement set is repeated in accordance with the repetition of the pitch angle arrangement set arranged regularly in the circumferential direction around the center axis.

8. The motor according to claim 7, wherein twelve teeth are arranged around the center axis, a total angle of the pitch angle arrangement set is 120°, the field magnet has four poles in the circumferential direction around the center axis.

9. The motor according to claim 8, wherein the motor is driven by a rectangular wave energization method.

10. The motor according to claim 9, wherein the core is formed by laminating thin steel sheets while rotating a direction of the sheets in accordance with the repetition of the pitch angle arrangement set.

11. The motor according to claim 10, wherein:
tip ends of the teeth are directed to the center axis; and
the field magnet is opposed to inner peripheral surfaces of the teeth.

12. The motor according to claim 11, wherein any two or more magnetic pole boundaries of the field magnet do not match with the slot between the teeth at the same time in any of cross section intersecting the center axis at right angles.

13. The motor according to claim 12, wherein in the teeth disposed radially, tip end widths of any of the adjacent teeth are different from each other.

14. The motor according to claim 13, further comprising a plurality of coils wound in a distributed manner; wherein:
each coil extends through three teeth comprising a tooth having narrowest width of the teeth among the three teeth interposed between the other two teeth; and
the coils are disposed a same number each on each of inner and outer peripheral sides of the teeth.

15. The motor according to claim 14, wherein the motor is a drive source which assists driving operation of a vehicle.

16. The motor according to claim 15, wherein the motor directly assists a power steering system of an automobile.

17. An electric motor comprising:
a stator having an armature;
a rotor having a field magnet for generating a torque around a center axis between the armature and the rotor; and
a bearing mechanism for supporting the rotor around the center axis such that the rotor can rotate relative to the stator; wherein
the field magnet has four poles in a circumferential direction around the center axis, a plurality of teeth of a core of the armature are disposed radially around the center axis, a gap is formed between inner tops of adjacent teeth and a pitch angle of the gap is defined around the center axis, a pitch angle arrangement set which has at least two different pitch angles formed between the adjacent teeth is defined, the pitch angle arrangement set is repeated three or more times in the circumferential direction around the center axis,
a tip end width is formed at inner top of tooth, an angle of a tip end width of tooth is defined around the center axis, a tip end width arrangement set which has at least two different tip end widths of the teeth is defined, the tip end width arrangement set is repeated in accordance with the repetition of the pitch angle arrangement set arranged regularly in the circumferential direction around the center axis, a slot gap is formed between the tip ends of adjacent teeth and a slot angle of the slot gap is defined around the center axis,
a core of the armature comprises a total twelve teeth in which an arrangement set defined using three kinds of teeth a, b and c which are combinations of sizes of θw1 and W1, θw2 and W2, and θw3 and W3 which are angles of tip end widths around the center axis and width of thinnest portion of the teeth is repeated three times in the circumferential direction in a radially inward around the center axis,
the angles of tip end widths are in a relation of θw1>θw2>θw3, and the thinnest widths are in a relation of W1>W2>W3,
the arrangement is four of teeth in an order of a, b, a, c,
a pitch angle θ1 between the teeth a and b indicated with angle around the center axis, a pitch angle θ2 between the teeth a and c, a slot angle θ between the teeth tip ends, and the tip end width angles of the teeth are in a relation of
θ1=30°+α, θ2=30°−α, θw3>>α>0°, 2α>θ≧0°, 2θw3>θw1, 40°−(4/3)(α+θ)>θw1>30°, 30°−2(α+θ)>θw3>20°−(2/3)(α+θ), θw2=θw3+4α
(preferable α is about 1°),
the motor further comprises total six coils wound in a distributed manner, the six coils are disposed such that three of them is disposed on each of inner and outer peripheral sides of the teeth, each coil extends through three teeth comprising the teeth a and the tooth b or c interposed between the teeth a, and
the motor is driven by energizing the coil with rectangular current.

18. The motor according to claim 17, wherein the core is formed by laminating thin steel sheets while rotating a direction of the sheets in accordance with a repetition of the pitch angle arrangement set.

19. The motor according to claim 18, wherein a polarized phase of the field magnet or disposition phase of the teeth has a skew structure which is gradually varied depending upon position in the center axis direction.

20. The motor according to claim 19, wherein the motor directly assist a power steering system of an automobile.
